(19) United States
(12) Patent Application Publication
(10) Pub. No.: US 2026/0146648 A1
(43) Pub. Date: May 28, 2026

(54) BEARING CAGE WITH POLYGONAL POCKETS

(71) Applicant: AKTIEBOLAGET SKF, GOTEBORG (SE)

(72) Inventor: Brian LARSEN, Scottville, MI (US)

(21) Appl. No.: 18/959,929

(22) Filed: Nov. 26, 2024

(51) Int. Cl. F16C 33/38; F16C 33/66

(52) U.S. Cl. CPC F16C 33/3887; F16C 33/6614; F16C 2208/00

(57) ABSTRACT

A ball bearing includes an inner body having an inner raceway surface and a central axis and an outer body disposed about the inner body so as to define an annular space, the outer body having an outer raceway surface. A plurality of balls are disposed within the annular space and rollable simultaneously along the inner raceway surface and the outer raceway surface.

A bearing cage is disposed within the annular space between the inner ring and the outer ring and having a plurality of pockets spaced circumferentially about the central axis. Each one of the plurality of balls is disposed within a separate one of the plurality of pockets and each pocket is defined by an enclosed polygonal surface.

### BACKGROUND OF THE INVENTION

The present invention relates to bearings, and more particularly to rolling element bearings having cages.

Rolling element bearings are well known and include an inner body having an inner raceway surface, an outer body having an outer raceway surface and a plurality of rolling elements disposed between and radially coupling the inner and outer bodies so as to rotatably couple an inner member, such as a shaft, etc., with an outer member, such as a housing, a wheel hub, etc. Certain rolling element bearings include a cage for maintaining a desired circumferential spacing between the rolling elements, which may be balls, cylinders, spheroids, etc. Specifically, the cage includes a plurality of circumferentially spaced pockets, which may be entirely enclosed or have an open axial side, and each rolling element is disposed within a separate one of the pockets.

Typically, a lubricant such as oil or grease is provided within the space between the inner and outer bodies of the bearing in order to reduce friction between the points of contact between the rolling elements and the raceway surfaces, as well as between the rolling elements and the surfaces of the cage pockets. However, in certain applications such as semiconductor manufacturing, the type of lubricant is generally restricted to specific types of grease which can withstand vacuum environments. Also, the amount of such grease is limited in order to avoid the grease from passing out of the bearing and causing contamination. Normally, a bearing typically has 30% to 40% of the free volume between the inner and outer bodies/rings filled with grease, but in these applications, the amount of grease is limited to about 10% of the free volume.

As a result, when the limited amount of grease breaks down, the grease loses the ability to adequately lubricate the contact points until friction torque becomes excessive and/or the locating accuracy of the bearing is reduced to below acceptable levels. At either point, the bearing is typically replaced.

### SUMMARY OF THE INVENTION

In an aspect, the present invention is a ball bearing includes an inner body having an inner raceway surface and a central axis and an outer body disposed about the inner body so as to define an annular space, the outer body having an outer raceway surface. A plurality of balls are disposed within the annular space and rollable simultaneously along the inner raceway surface and the outer raceway surface. A bearing cage is disposed within the annular space between the inner ring and the outer ring and having a plurality of pockets spaced circumferentially about the central axis. Each one of the plurality of balls is disposed within a separate one of the plurality of pockets and each pocket is defined by an enclosed polygonal surface.

Preferably, the bearing cage includes an annular body having an inner circumferential surface and an outer circumferential surface. With such a body, the polygonal surface of each one of the plurality of pockets extends radially between the inner and outer circumferential surfaces of the annular body. Also, the polygonal surface of each one of the plurality of pockets has a plurality of corners, a storage space being defined between each corner and the ball disposed within the pocket defined by the polygonal surface. A quantity of lubricant disposed within the annular space between the inner and outer rings, a portion of the quantity of lubricant is disposed within at least some of the storage spaces of each one of at least a portion of the plurality of pockets. Further, the polygonal surface of each one of the plurality of pockets has at least three surface sections spaced about a center of the pocket such that each corner of the one pocket is defined at an intersection of each pair of adjacent surface sections of the polygonal surface.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a broken-away, axial cross-sectional view of a bearing with a cage with polygonal pockets in accordance with the present invention, shown mounted between a shaft and a housing;

FIG. 2 is a perspective view of the cage;

FIG. 3 is a broken-away, front plan view of one polygonal pocket of the cage, shown formed as a dodecagon;

FIG. 4 is a broken-away, perspective view of the pocket of FIG. 3;

FIG. 5 is a broken-away, front plan view of one polygonal pocket of the cage, shown formed as a decagon;

FIG. 6 is a broken-away, front plan view of one polygonal pocket of the cage, shown formed as an octagon;

FIG. 7 is a broken-away, front plan view of one polygonal pocket of the cage, shown formed as a hexagon;

FIG. 8 is another view of the pocket of FIG. 3, shown with an installed ball; and

FIG. 9 is a greatly enlarged view of a portion of FIG. 8, shown with lubricant within a storage space.

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description.

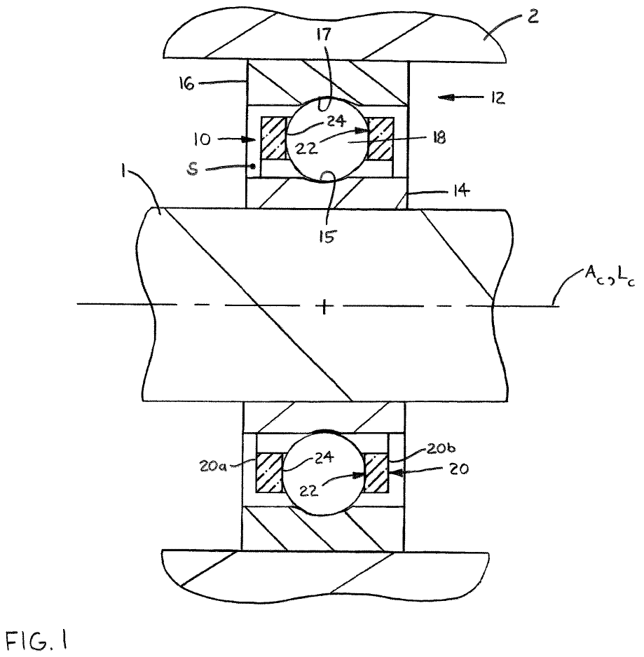

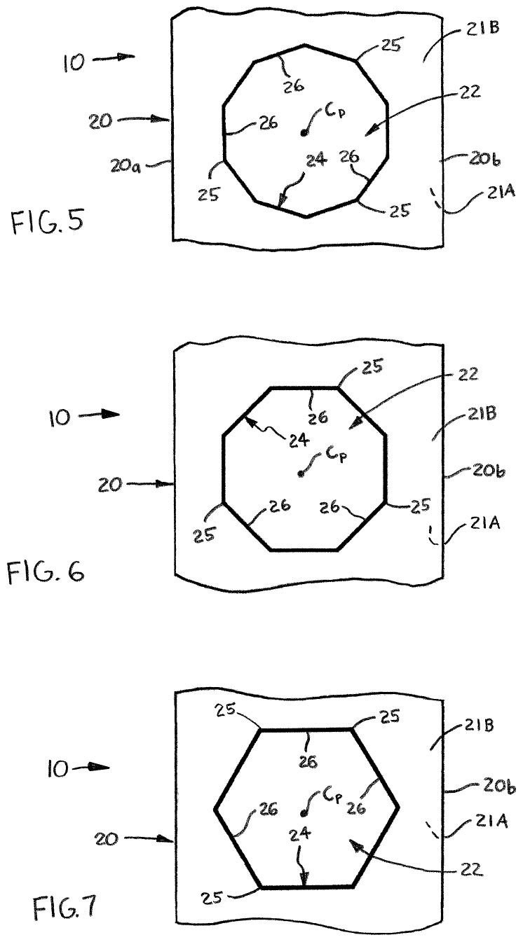

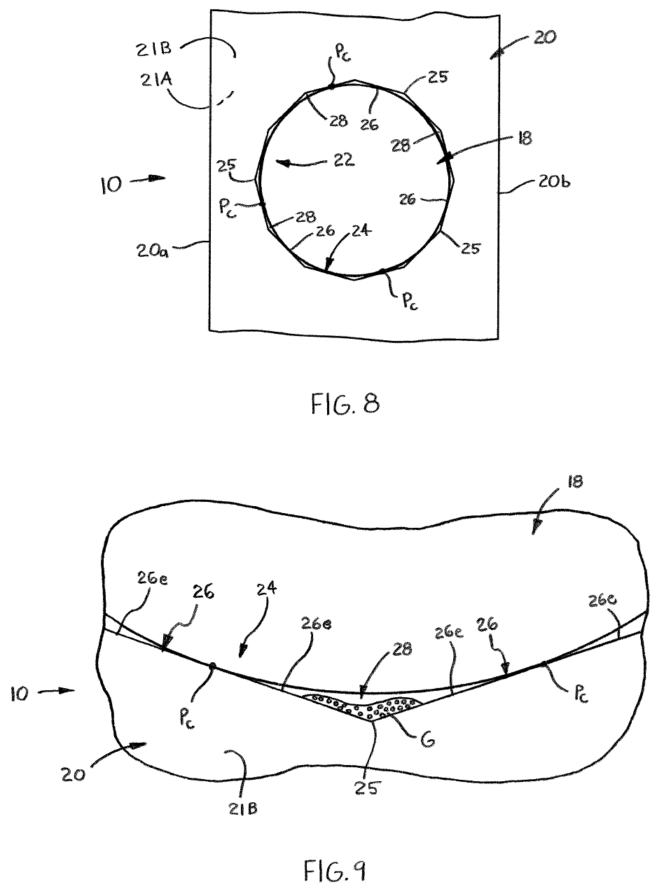

Referring now to the drawings in detail, wherein like numbers are used to indicate like elements throughout, there is shown in FIGS. 1-9 a cage 10 for a ball bearing 12 that is preferably used in a vacuum or other specialty environment, in particular for microchip manufacturing. The bearing 12 includes an inner body 14, which has an inner raceway surface 15 and a central axis A_{C}, and an outer body 16 disposed about the inner body 14 so as to define an annular interior space S, the outer body 16 having an outer raceway surface 17. Preferably, the inner and outer bodies 14, 16 are each formed as a ring, but one or both may be formed in any other appropriate manner, such as a hub, a sleeve, a housing, etc., the inner body/ring 14 being installed about an inner member 1, such as a shaft, and the outer body/ring 16 being installed within an outer member 2, such as a housing. Further, a plurality of balls 18 are disposed within the annular space S and are each rollable simultaneously along the inner raceway surface 15 and the outer raceway surface 17.

The bearing cage 10 is disposed within the annular space S between the inner ring 14 and the outer ring 16 and has a centerline L_{C}, which is coaxial with the central axis A_{C}, and a plurality of pockets 22 spaced circumferentially about the centerline L_{C}. Each one of the plurality of balls 18 is disposed within a separate one of the plurality of pockets 22, i.e., one ball 18 within each pocket 22, so as to establish a desired spacing distance (not indicated) between the balls 18. Furthermore, each pocket 22 is defined by an enclosed polygonal surface 24, preferably including at least five surface sections 26 as described below, so as to provide a plurality of storage spaces 28 (FIGS. 8 and 9) for lubricant, particularly for grease G.

More specifically, the cage 10 includes an annular body 20 having an inner circumferential surface 21A, an opposing outer circumferential surface 21B, and first and second axial ends 20a, 20b, respectively. The polygonal surface 24 of each one of the plurality of pockets 22 extends radially between the inner and outer circumferential surfaces 21A, 21B of the annular body 20. Each polygonal surface 24 of the plurality of pockets 22 has a plurality of corners 25 spaced circumferentially about a center C_{P} of the pocket 22. As such, a separate one of the storage spaces 28 is defined between each corner 25 and the ball 18 that is disposed within the pocket 22 defined by the particular polygonal surface 24.

When a quantity of lubricant/grease is injected into or otherwise applied within the bearing 12 so as to be disposed within the annular interior space S, in addition to portions that at least partially coat the raceways 15, 17, the balls 18 and contact points P_{C} between the balls 18 and the polygonal surfaces 24, a portion of the quantity of lubricant/grease G becomes disposed within at least some of the storage spaces 28 of each one of at least a portion of the plurality of pockets 22. Ideally, grease G becomes disposed within every storage space 28 of all of the pockets 22 when the bearing 12 is lubricated prior to use of the bearing 12. Thereafter, during use, the grease G is available to lubricate the contact points P_{C} between the balls 18 and the cage 10 and to also be transferred by means of the balls 18 to the raceway surfaces 15, 17. Thus, by providing the lubricant storage spaces 28, the amount of time that a given quantity of grease G can effectively lubricate the bearing 12 is substantially increased.

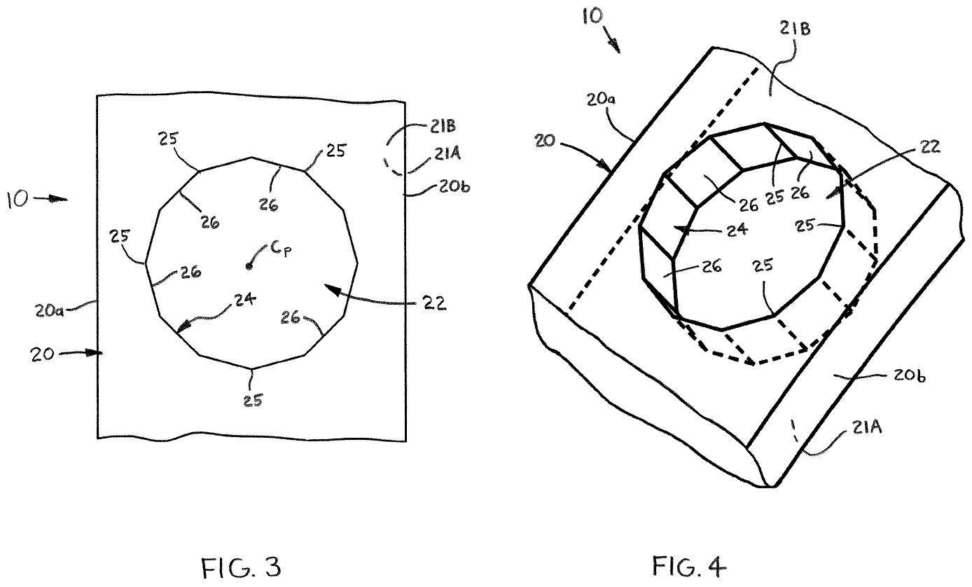

Referring now to FIGS. 3-7, the polygonal surface 24 of each one of the plurality of pockets 22 has at least three surface sections 26, and preferably at least five surface sections 26, spaced about a center C_{P} of the pocket 22. As such, each corner 25 of each one of the pockets 22 is defined at an intersection of each pair of adjacent surface sections 26 of the polygonal surface 24. By forming each pocket 22 with a polygonal surface 24 rather than a circular cylindrical surface (not shown) of a typical ball bearing cage, each ball 18 contacts the associated pocket 22 at the plurality of separate contact points P_{C} rather than along a continuous circular line. As a result, there is substantially less friction between the balls 18 and the cage 10. Also, with a ball 18 disposed therewithin, each pocket 22 has a plurality of exposed portions 26e (FIG. 9) of the surface sections 26, which extend between each contact point P_{C} and an adjacent one of the corners 25, onto which grease may adhere so as to increase the quantity of grease accumulated within each storage space 28.

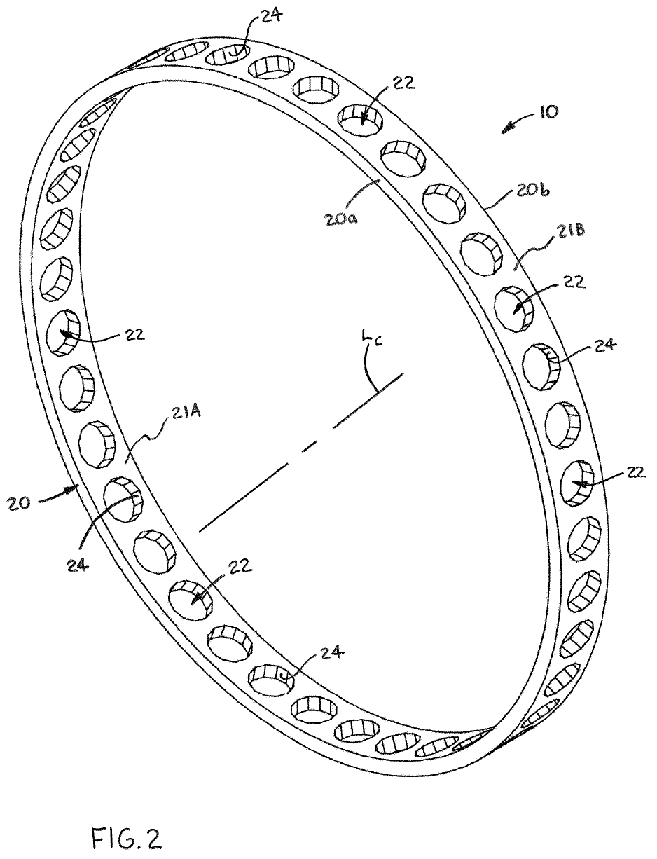

Preferably, the polygonal surface 24 has at least five surface sections 26, as discussed above, so as to be formed as a pentagon (not shown) and most preferably has twelve surface sections 26 so as to be formed as a dodecagon, as shown in FIGS. 2-4 and 8. However, the polygonal surface 24 of each one of the plurality of pockets 22 may alternatively be formed as a decagon (FIG. 5), as an octagon (FIG. 6), or as a hexagon (FIG. 7). Although not presently preferred, the polygonal surface 24 may alternatively be triangular, have more than twelve surface sections 26 or any desired number or surface sections 26 (none shown).

In any case, when the number of surface sections 26 increases (e.g., twelve surface sections 26 or “sides” versus eight surface sections 26), the number of corners 25 and storage spaces 28 increase, but the volume within each storage space 28 and the amount of exposed surface portions 26e correspondingly decreases, and vice-versa. Thus, the selection of a particular type of polygonal surface 24 is a balance of the size/volume of each storage space 28 versus the number of storage spaces 28 of each pocket 22.

Furthermore, the cage 10 is preferably formed of a polymeric material in a molding process or by additive manufacturing. However, the cage 10 may be formed of any other appropriate material and/or manufacturing process, such as for example, being formed of a metallic material in a stamping process.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

I claim:

1. A ball bearing comprising:
an inner body having an inner raceway surface and a central axis;
an outer body disposed about the inner body so as to define an annular space, the outer body having an outer raceway surface;
a plurality of balls disposed within the annular space and rollable simultaneously along the inner raceway surface and the outer raceway surface; and
a bearing cage disposed within the annular space between the inner ring and the outer ring and having a plurality of pockets spaced circumferentially about the central axis, each one of the plurality of balls being disposed within a separate one of the plurality of pockets and each pocket being defined by an enclosed polygonal surface.

2. The ball bearing as recited in claim 1, wherein the bearing cage includes an annular body having an inner circumferential surface and an outer circumferential surface, the polygonal surface of each one of the plurality of pockets extending radially between the inner and outer circumferential surfaces of the annular body.

3. The ball bearing as recited in claim 1, wherein the polygonal surface of each one of the plurality of pockets has a plurality of corners, a storage space being defined between each corner and the ball disposed within the pocket defined by the polygonal surface.

4. The ball bearing as recited in claim 3, further comprising a quantity of lubricant disposed within the annular space between the inner and outer rings, a portion of the quantity of lubricant being disposed within at least some of the storage spaces of each one of at least a portion of the plurality of pockets.

5. The ball bearing as recited in claim 3, wherein the polygonal surface of each one of the plurality of pockets has at least three surface sections spaced about a center of the pocket such that each corner of the one pocket is defined at an intersection of each pair of adjacent surface sections of the polygonal surface.

6. The ball bearing as recited in claim 1, wherein the polygonal surface of each one of the plurality of pockets has at least three surface sections spaced about a center of the pocket such that a plurality of corners are each defined an intersection of each pair of adjacent surface sections of the polygonal surface, each corner providing a storage space for lubricant.

7. The ball bearing as recited in claim 1, further comprising a lubricant disposed within the annular space between the inner and outer rings and distributed within the plurality of pockets of the cage.

8. The ball bearing as recited in claim 1, wherein the polygonal surface of each one of the plurality of pockets is one of a hexagon, an octagon, a decagon and a dodecagon.

9. The ball bearing as recited in claim 1, wherein the cage is formed of a polymeric material in a molding process or by additive manufacturing.

10. A ball bearing comprising:
an inner ring having an inner race and a central axis;
an outer ring disposed about the inner ring so as to define an annular space, the outer ring having an outer race;
a plurality of balls;
a bearing cage disposed between the inner ring and the outer ring and having a plurality of pockets spaced circumferentially about the central axis, each one of the plurality of balls being disposed within a separate one of the plurality of pockets and each pocket being defined by an enclosed polygonal surface, each polygonal surface having a plurality of corners such that a separate storage space is defined between each corner and the one of the plurality of balls disposed within the pocket defined by the polygonal surface; and
a quantity of lubricant disposed within the annular space between the inner and outer rings, a portion of the quantity of lubricant being disposed within at least some of the storage spaces of each one of at least a portion of the plurality of pockets.

11. The ball bearing as recited in claim 10, wherein the bearing cage includes an annular body having an inner circumferential surface and an outer circumferential surface, the polygonal surface of each one of the plurality of pockets extending radially between the inner and outer circumferential surfaces of the annular body.

12. The ball bearing as recited in claim 10, wherein the polygonal surface of each one of the plurality of pockets has at least three surface sections spaced about a center of the pocket such that each one of the plurality of corners of each one of the pockets is defined an intersection of each pair of adjacent surface sections of the polygonal surface.

13. The ball bearing as recited in claim 10, wherein the polygonal surface of each one of the plurality of pockets is one of a hexagon, an octagon, a decagon and a dodecagon.

14. The ball bearing as recited in claim 10, wherein the cage is formed of a polymeric material in a molding process or by additive manufacturing.
